(19) United States
(12) Patent Application Publication
(10) Pub. No.: US 2008/0096110 A1
(43) Pub. Date: Apr. 24, 2008

(54) NEGATIVE ELECTRODE AND NON-AQUEOUS ELECTROLYTE SECONDARY BATTERY USING THE SAME

(75) Inventors: Yasuhiko BITO, Osaka (JP); Youko SANO, Osaka (JP); Teruaki YAMAMOTO, Osaka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/763,091

(22) Filed: Jun. 14, 2007

(30) Foreign Application Priority Data
Jun. 16, 2006 (JP) 2006-167201

(51) Int. Cl. H01M 4/38; H01M 4/48

(52) U.S. Cl. 429/220; 429/209; 429/218.1; 429/223; 429/231.5; 977/742; 977/734

(57) ABSTRACT

The negative electrode for a non-aqueous electrolyte secondary battery of the present invention includes a conductive porous substrate, and a conductive material and an active material filled in pores of the porous substrate. The active material contains at least one of a metal element and a semi-metal element capable of reversibly absorbing and desorbing lithium.

### FIELD OF THE INVENTION

The present invention relates to a non-aqueous electrolyte secondary battery and, in particular, to an improved negative electrode for a non-aqueous electrolyte secondary battery.

### BACKGROUND OF THE INVENTION

Conventionally, many studies have been done on non-aqueous electrolyte secondary batteries with high voltage and high energy density. For positive electrodes of non-aqueous electrolyte secondary batteries, transition metal oxides or transition metal chalcogen compounds are used. For example, LiMn₂O₄, LiCoO₂, LiNiO₂, V₂O₅, Cr₂O₅, MnO₂, TiS₂ and MoS₂ are used. These compounds have a layered or tunnel crystal structure. Accordingly, the compounds are capable of absorbing and desorbing lithium ions. For negative electrodes, carbon materials capable of reversibly absorbing and desorbing lithium, such as graphite, for example, are used. Use of carbon materials makes it possible to prepare lithium ion batteries having excellent cycle life and safety.

However, since such graphite materials have a theoretical capacity and a theoretical density as relatively small as 372 mAh/g and 2.2 g/cm³, respectively, use of metal materials capable of achieving capacity higher than that of graphite materials as a negative electrode active material has been studied. For example, materials containing silicon (Si) having high capacity of a theoretical capacity of 4199 mAh/g and a theoretical density of 2.33 g/cm³ have been researched and developed.

However, using a material containing Si for a negative electrode often causes decrease in charge/discharge cycle performance of batteries. The charge/discharge cycle performance is thought to be decreased mainly because active material particles containing Si repeatedly expand and shrink with absorption and desorption of lithium due to repeated charge/discharge, and the contact resistance of active material particles is increased in the negative electrode, deteriorating a current collection network.

As a method of suppressing such deterioration of a current collection network, Japanese Laid-open Patent Publication No. 2004-103340, for example, proposes using low crystalline or amorphous alloy material comprising solid phase A and solid phase B as a negative electrode material and optimizing the size of the crystallite of the alloy material. The method makes it possible to improve current collection deterioration in an active material due to charge/discharge and suppress decrease of charge/discharge cycle performance.

In addition to the above, Japanese Laid-open Patent Publication No. 2004-265718, for example, proposes using a negative electrode in which foam metal is filled with graphite as a negative electrode active material. Japanese Laid-open Patent Publication No. 2004-220910 proposes using a negative electrode material comprising Si and carbon nanotube. Japanese Laid-open Patent Publication No. 2001-196064 proposes using a negative electrode material in which carbon nanotube is grown on Si particle surfaces using a catalytic metal (Co, Ni, Fe).

However, in the methods of Japanese Laid-open Patent Publication Nos. 2004-103340, 2004-220910 and 2001-196064, suppressing expansion and shrinkage of a negative electrode in charge/discharge is difficult, and cracks may be generated in the negative electrode or the active material may fall off from the negative electrode.

Also, another possible approach is to use Si instead of graphite in the method described in Japanese Laid-open Patent Publication No. 2004-265718 proposing using a negative electrode in which foam metal is filled with graphite as a negative electrode active material. However, since Si has a rate of expansion about four times higher than that of graphite when the battery is charged, even if current collection properties of active material particles near the foam metal can be ensured, current collection properties among active material particles may be deteriorated due to shrinkage of active material particles when the battery is discharged.

Also, since a negative electrode generally comprises a porous mixture layer containing an active material, a conductive material and a binder, expansion and shrinkage of the negative electrode often occur unevenly.

Large and uneven volume change in a negative electrode results in generation of cracks in the mixture layer or falling off of the active material from the mixture layer, causing current concentration in the negative electrode and often causing uneven charge/discharge reaction. This generates heavily charged regions and lightly charged regions in the negative electrode, often causing deterioration of negative electrode properties.

In addition, large volume change due to charge/discharge destroys a current collection network among active material particles and active material particles not contributing to charge/discharge reaction are increased, easily resulting in deterioration of negative electrode properties.

In such circumstances, to solve the above conventional problem, an object of the present invention is to provide a negative electrode for a non-aqueous electrolyte secondary battery, in which generation of cracks in the negative electrode and falling off of an active material from the negative electrode are suppressed in charge/discharge and which has uniform and excellent current collection properties. Another object of the present invention is to provide a non-aqueous electrolyte secondary battery having excellent charge/discharge cycle performance by using the above negative electrode.

### BRIEF SUMMARY OF THE INVENTION

The present inventors have conducted detailed studies on a negative electrode using an active material containing at least one of a metal element and a semi-metal element capable of reversibly absorbing and desorbing lithium aiming at improvement of the charge/discharge cycle performance of a non-aqueous electrolyte secondary battery.

As a result, they have found that excellent charge/discharge cycle performance can be achieved when the negative electrode comprises a conductive porous substrate, and a conductive material and an active material filled in pores of the porous substrate, and the active material contains at least one of a metal element and a semi-metal element capable of reversibly absorbing and desorbing lithium.

Preferably, the porous substrate contains at least one selected from the group consisting of nickel, copper, titanium, stainless steel and carbon.

Preferably, the conductive material contains at least one selected from the group consisting of nickel, copper, titanium, stainless steel and carbon.

Preferably, the conductive material is at least particulate or fibrous.

Preferably, the porous substrate has an average pore size of 1 to 100 μm and the conductive material comprises particles having an average particle size of 5 to 100 nm.

Preferably, the porous substrate has an average pore size of 1 to 100 μm and the conductive material comprises fibers having an average fiber diameter of 5 to 50 nm and an average fiber length of 0.05 to 50 μm.

Preferably, the porous substrate comprises a foamed body or a sintered body containing at least one selected from the group consisting of nickel, copper, titanium and stainless steel.

Preferably, the porous substrate comprises at least one selected from the group consisting of cloth, felt and paper which contain carbon.

Preferably, the conductive material is at least one of carbon nanotube and carbon nanofiber.

Preferably, the active material contains at least one of Si and Sn.

Preferably, the active material is an alloy comprising a first phase containing Si as a main component and a second phase containing Si and at least one selected from Ti, Zr, Ni and Cu. Preferably, at least one phase of the first phase and the second phase is in at least one of amorphous and low crystalline states.

Preferably, the active material is at least one of SiOₓ where 0.1≦x≦2.0 and SnO_{y} where 0.1≦y≦2.0.

Preferably, the negative electrode has a porosity of 5 to 50%.

The present invention also relates to a non-aqueous electrolyte secondary battery comprising the above negative electrode, a positive electrode and an electrolyte.

The present invention makes it possible to maintain uniform and stable current collection properties of a negative electrode in charge/discharge and provide excellent charge/discharge cycle performance. Specifically, since an active material is contained in a porous substrate, generation of cracks in a negative electrode or falling off of the active material from the negative electrode found in conventional negative electrodes having a negative electrode mixture layer can be suppressed even when volume change of active material particles is large in charge/discharge, making it possible to maintain the form of the negative electrode. Further, use of a conductive material having a diameter smaller than the average pore size of a porous substrate makes it possible to maintain a good current collection network among active material particles.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view showing partly in section of a coin type battery which is an example of the non-aqueous electrolyte secondary battery of the present invention.

### DETAILED DESCRIPTION OF THE INVENTION

The negative electrode for a non-aqueous electrolyte secondary battery of the present invention comprises a conductive porous substrate, and a conductive material and an active material filled in pores of the porous substrate, and the active material contains at least one element of a metal element and semi-metal element capable of reversibly absorbing and desorbing lithium.

The present invention makes it possible to maintain uniform and stable current collection properties of a negative electrode in charge/discharge and provide excellent charge/discharge cycle performance. As described above, since an active material is contained in the porous substrate, generation of cracks in a negative electrode or falling off of an active material from the negative electrode found in conventional negative electrodes having a negative electrode mixture layer can be suppressed even when volume change of active material particles is large in charge/discharge.

(1) Negative Electrode Active Material

As described above, the negative electrode active material contains at least one element of a metal element and a semi-metal element capable of reversibly absorbing and desorbing lithium.

Examples of such elements include Mg, Ba, Sr, Ca, La, Ce, Si, Ge, P, B, Bi, Sb, Al, In, S, Se, Te, Zn, Pb, Si, Ag, Sn, Cd, Tl and Hg. These elements may be used alone or in combination of two or more. Of the elements, Si or Sn is particularly preferred in consideration of the capacity.

As the active material, for example, a single-element substance of any of the above elements, an alloy containing any of the above elements or a compound containing any of the above elements may be used.

As an alloy containing any of the above elements, an alloy comprising an A phase (first phase) containing Si as a main component and a B phase (second phase) comprising an intermetallic compound of a transition metal element and Si is preferred.

The A phase is capable of absorbing and desorbing Li, i.e., capable of electrochemically reacting with Li.

Preferably, the A phase is composed of a single-element substance of Si. In that case, the amount of Li that can be absorbed or desorbed per unit weight or unit volume of the alloy significantly increases. However, since the single-element Si substance is a semiconductor, it has poor electron conductivity. Accordingly, to improve the electron conductivity of the A phase, about 5% by weight of an element such as phosphorus (P), boron (B), hydrogen (H) or a transition metal element is preferably added.

The B phase comprises an intermetallic compound containing Si and a transition metal element. Preferably, the transition metal element contained in the B phase is selected from the group consisting of Ti, Zr, Ni and Cu. More preferably, the transition metal element is at least one of Ti and Zr. The alloy composed of the transition metal element and Si has high electron conductivity and high hardness. When the transition metal element is Ti, preferably the B phase contains TiSi₂.

The B phase has high affinity with the A phase. In particular, the B phase plays a role of relaxing the stress generated in particles when the alloy volume is increased by charging. For this reason, cracks are hardly generated at the interface of the A phase and the B phase in particles in charge/discharge. The B phase has higher electron conductivity and higher hardness compared to a single-element Si phase. The presence of the B phase makes it possible to make up for the low electron conductivity of the A phase and also relax the stress caused by expansion to suppress cracks of alloy particles. The B phase may contain a plurality of intermetallic compounds of different compositions, which contain an identical transition metal element, or a plurality of intermetallic compounds of different compositions, which contain a different transition metal element. For example, with M representing a transition metal element, MSi₂ and MSi may be present in alloy particles as the B phase. Also, M¹Si₂ and M²Si₂ (M¹≠M²) may be present in alloy particles as the B phase.

The content of the A phase in the alloy is preferably 5 to 95 parts by weight per 100 parts by weight of the total of the A phase and the B phase. The higher the content of the A phase, the larger the capacity, but the greater the volume change in charge/discharge. Accordingly, for maintaining the current collection properties at high level in charge/discharge cycle, the content of the A phase is more preferably 80 parts by weight or less, still more preferably 50 parts by weight or less per 100 parts by weight of the total of the A phase and the B phase.

As described above, in the case of the above alloy, since the B phase relaxes the stress generated in the alloy due to expansion of the A phase when absorbing Li, generation of cracks of particles in charge/discharge is suppressed. As a result, a non-aqueous electrolyte secondary battery having excellent charge/discharge cycle performance can be obtained.

Since cracks of alloy particles due to expansion caused by absorbing Li are difficult to occur when using a low crystalline or amorphous alloy material, preferably at least one of the A phase and the B phase is low crystalline or amorphous.

When the alloy containing the A phase and the B phase is low crystalline or amorphous, the crystallite (crystal particle) preferably has a size of 100 nm or less. The crystallite more preferably has a size of 5 to 100 nm. When the crystallite has a size of more than 100 nm, the grain boundaries among crystallites are decreased, and thus the advantage of suppressing cracks of particles is reduced. When the crystallite has a size of less than 5 nm, the grain boundaries among crystallites are increased, and thus the electron conductivity of the alloy may be decreased. Such a lower electron conductivity of the alloy is likely to cause a higher polarization of the negative electrode and a lower battery capacity.

The state (crystallinity) of the A phase and B phase constituting the alloy can be determined, for example, by the presence of peaks attributable to the crystal plane of the A phase and B phase in an X-ray diffraction pattern obtained by X-ray diffractometry in a range of a diffraction angle 2θ of 10° to 80° using CuKα as an X-ray source.

For example, for the A phase composed of Si, a peak corresponding to crystal plane (111) is observed at a diffraction angle 2θ of 28.4°, a peak corresponding to crystal plane (220) at a diffraction angle 2θ of 47.3°, a peak corresponding to crystal plane (311) at a diffraction angle 2θ of 56.1°, a peak corresponding to crystal plane (400) at a diffraction angle 2θ of 69.1° and a peak corresponding to crystal plane (331) at a diffraction angle 2θ of 76.4°, reflecting crystal planes of Si. Also, the peak corresponding to crystal plane (111) observed at a diffraction angle 2θ of 28.4° often has the maximum intensity. However, when the phase is composed of a low crystalline region, no sharp peak but a relatively broad peak is observed. On the other hand, when the phase is composed of an amorphous region, a halo pattern which is too broad to recognize the half width is observed in an X-ray diffraction pattern of alloy particles obtained by X-ray diffractometry.

The crystallite size can be determined by X-ray diffractometry. Specifically, in an X-ray diffraction pattern of alloy particles obtained by X-ray diffractometry, the half width of the peak attributable to each phase is determined, and the crystallite size can be calculated from the half width and the Scherrer formula. When each phase has a plurality of peaks, the half width of the peak with the highest intensity may be determined, to which the Scherrer formula is applied. More specifically, crystallite size D is calculated by the formula (1) shown below.
D(nm)=0.9×λ/(β×cos θ) (1)
in which λ: X-ray wavelength (m, 1.5405 nm in the case of CuKα), β: half width (rad) of the peak, θ: half value of the peak angle 2ζ (rad)

While generally a peak with the highest intensity may be checked in a diffraction angle 2θ range of 10 to 80°, a peak with the highest intensity in a diffraction angle 2θ range of 20 to 35° is more preferably checked.

In an X-ray diffraction pattern obtained by X-ray diffractometry of an alloy material using CuKα as a radiation source, the half width of the diffraction peak with the highest intensity observed in a diffraction angle 2θ range of 10 to 80° or of 20 to 35° is preferably 0.09° or more. In that case, the crystallite size is determined to be 100 nm or less.

In addition to the above, the crystallite size can be directly measured by observing cross sections of alloy particles using, for example, atomic force microscopy (AFM) or transmission electron microscopy (TEM). Also, the abundance ratio (phase composition) of the A phase and B phase in an alloy can be measured, for example, by an energy dispersive X-ray analyzer (EDX) based on energy dispersive X-ray spectroscopy (EDS).

Methods of preparing amorphous or low crystalline alloy include mechanical alloying, casting, gas atomization, liquid quenching, ion beam sputtering, vacuum deposition, plating and chemical vapor reaction. The mechanical alloying method is preferred because the crystallinity of the phases can be easily controlled.

In mechanical alloying, different metal elements can be reacted and alloyed mechanically utilizing impact energy, and thus amorphous or low crystalline alloy can be easily prepared. Also, mechanical alloying provides much more homogeneous reaction of alloying than the quenching method which is typical of conventional methods of preparing alloy materials. In the quenching method, the reaction tends to be nonhomogeneous or nonequilibrium because molten alloy is rapidly solidified by cooling. As herein described, amorphous or low crystalline, homogeneous alloy can be easily prepared in mechanical alloying.

The form of raw materials of the above negative electrode material is not particularly limited as long as the component ratio necessary for a negative electrode material is fulfilled. For example, a material in which single-element substances constituting a negative electrode material are mixed at an intended component ratio, or an alloy, a solid solution or an intermetallic compound with an intended component ratio may be used.

Since mechanical alloying efficiently makes an effect of alloying (making finer crystallites by mixing different elements) on an alloy material containing Si, it is preferred that a raw material containing Si and a raw material containing a transition metal element are mixed and then allowed mechanically.

In addition, mechanical alloying after mixing a raw material containing Si, a raw material containing a transition metal element used for forming the above intermetallic compound containing Si and a raw material containing an element such as Fe as an additive to alloy is preferred.

In addition to the above methods, a mixture of raw materials may be melted and the molten mixture may be solidified by rapid cooling before mechanical alloying.

Mechanical alloying is a synthetic method in a dry atmosphere. When the range of the particle size of the resulting active material powder is too large after synthesis, pulverization or classification may be performed for adjusting the particle size. As a pulverizer, for example, a device such as an attritor, a vibrating mill, a ball mill, a planetary ball mill, a bead mill or a jet mill may be used.

Examples of compounds containing the above element include oxides, nitrides and carbonates containing the above element.

Of these, SiOₓ where 0.1≦x≦2.0 or SnO_{y} where 0.1≦y≦2.0 is a preferred compound. More preferably, the compound is SiOₓ where 0.15≦x≦1.2 or SnO_{y} where 0.15≦y≦1.2.

These compounds may be used alone or in combination of two or more. In consideration of cycle life, these compounds are also preferably low crystalline or amorphous for the same reason as for the alloy.

The method of preparing such a compound is not particularly limited as long as a low crystalline or amorphous compound can be prepared. Examples of the method include thermal oxidation of a metal raw material, the sol-gel method, vacuum deposition, sputtering, and reduction of a high-order oxide.

(2) Porous Substrate

The conductive, the layered porous substrate in the present invention has a function of maintaining the form of the negative electrode and also ensuring a good current collection network of the entire negative electrode, thereby retaining stable contact with conductive members (e.g., negative electrode current collectors, negative electrode cans) that are in contact with the substrate.

The porous substrate has, for example, a thickness of 0.1 to 0.5 mm and a porosity of 50 to 95%.

Preferably, the porous substrate is composed of a cloth, felt or uniaxially orientated sheet structure. For Example, woven fabrics, knitted fabrics, braids, laces, nets, felt, paper, nonwoven fabrics and mats can be used for the porous substrate. Of these, woven fabrics and felt are preferred.

Preferably, the porous substrate contains at least one selected from the group consisting of nickel, copper, titanium, stainless steel and carbon. These materials have high conductivity, are chemically stable against electrolyte, electrochemically stable and does not absorb or desorb lithium in the negative electrode potential range in charge/discharge.

Preferably, the porous substrate is a foamed body or a sintered body containing at least one selected from the group consisting of nickel, copper, titanium and stainless steel.

The foamed body is prepared, for example, by coating a foamed resin with metal by plating and heat treating. Typical examples of such a foamed body include foamed nickel available from Sumitomo Electric Industries, Ltd. (product name: Celmet). Also, a foamed body is prepared by applying a slurry containing metal powder to foam metal and then heat treating. A sintered body is prepared, for example, by molding metal fine particles, forming a porous material and then heat treating.

Preferably, the porous substrate is at least one selected from the group consisting of cloth, felt and paper which contain carbon. The cloth herein described is woven cloth. The felt is a mat of short carbon fiber formed using an organic binder. The paper is prepared from short carbon fiber by wet or dry paper making.

(3) Conductive Material

Examples of conductive materials include graphite such as natural graphite (flake graphite, etc.), artificial graphite and expanded graphite; carbon black such as acetylene black, ketjen black, channel black, furnace black, lamp black and thermal black; conductive fiber such as carbon fiber, carbon nanotube and metal fiber; metal powder such as copper powder and nickel powder; and organic conductive materials such as polyphenylene derivatives. These may be used alone or in combination of two or more.

Preferably, the conductive material contains at least one selected from the group consisting of nickel, copper, titanium, stainless steel and carbon. These materials have high conductivity, are chemically stable against electrolyte, electrochemically stable and does not absorb or desorb lithium in the negative electrode potential range in charge/discharge. The conductive material is at least particulate or fibrous.

In consideration of the density, stability against electrolyte and capacity, a carbon material is preferably used for the conductive material.

Preferably, the carbon material is at least one selected from the group consisting of carbon nanotube, carbon nanofiber and vapor grown carbon fiber.

Examples of forms of the carbon nanotube or carbon nanofiber include single wall, multi wall, coil and cup stack.

A catalyst may be used in the course of growth of carbon nanotube or carbon nanofiber. Examples of catalysts include transition metals, semi-metals, nonmetals, alkali metals and alkaline earth metals. As a transition metal, Ni, Co, Fe, Mo or Cr is preferred. As a semi-metal, B, Al, Ga, Si, Sn or Bi is preferred. As a nonmetal, F, P, S, Se, Br, Kr, I or Xe is preferred. As an alkali metal, Na or K is preferred. As an alkaline earth metal, Mg or Ca is preferred.

(4) Negative Electrode

In the negative electrode of the present invention, for example, at least a particulate active material and a particulate or fibrous conductive material are filled in pores of a porous substrate.

In a first preferred embodiment of the negative electrode of the present invention, a particulate conductive material having an average particle size of 5 to 100 nm is filled in pores of a porous substrate having an average pore size of 1 to 100 μm.

When the porous substrate has an average pore size of less than 1 μm, the particle size of active material particles to be filled in the pore at least needs to be smaller than 1 μm. In addition, for the size of active material particles, it is necessary to consider expansion at the time of charging. When using excessively fine particles as the active material, the cost will increase because steps of microfabrication, for example, pulverization, are complicated. Also, since the active material has too large a specific surface area, particles have increased interface resistance and the side reaction with electrolyte increases. As a result, it is very likely that the performance and reliability of the battery are lost. When the porous substrate has an average pore size of more than 100 μm, the current collection path from active material particles filled in pores to the porous substrate is extended, making it difficult to form an efficient current collection network.

When the particulate conductive material has an average particle size of less than 5 nm, the conductive material is extremely small and has reduced apparent density, and therefore volumetric efficiency in the negative electrode is decreased and the contact resistance between conductive materials tends to be increased. When the particulate conductive material has an average particle size of more than 100 nm, forming an efficient current collection network by utilizing pores of the porous substrate or the gap between active material particles becomes difficult.

In the first preferred embodiment, the active material particles filled in pores of the porous substrate with the conductive material have an average particle size of preferably 0.5 to 90 μm.

In a second preferred embodiment of the negative electrode of the present invention, a fibrous conductive material having an average fiber diameter of 5 to 50 nm and an average fiber length of 0.05 to 50 μm is filled in pores of a porous substrate having an average pore size of 1 to 100 μm.

When the fibrous conductive material has an average fiber diameter of less than 5 nm, the conductive material is extremely small and has reduced apparent density, and therefore volumetric efficiency in the negative electrode is decreased and the contact resistance between conductive materials tends to be increased. When the fibrous conductive material has an average fiber diameter of more than 50 nm, forming an efficient current collection network by utilizing pores of the porous substrate or the gap between active material particles becomes difficult.

When the fibrous conductive material has an average fiber length of less than 0.05 μm, sufficient electron conductivity between active material particles and between active material particles and the porous substrate is not achieved. Also, when the fibrous conductive material has an average fiber length of more than 50 μm, forming an efficient current collection network by utilizing pores of the porous substrate or the gap between active material particles becomes difficult.

In the second preferred embodiment, the active material particles filled in pores of the porous substrate with the conductive material have an average particle size of preferably 0.5 to 90 μm.

The negative electrode has a porosity of preferably 5 to 50%. When the negative electrode has a porosity of less than 5%, the reaction interface is not occupied by a sufficient amount of the electrolyte. Also, it is difficult to suppress expansion of the active material in charging. When the negative electrode has a porosity of more than 50%, pores are too large to form an efficient current collection network among active material particles and between active material particles and the substrate.

Although the content of the conductive material in the negative electrode is not particularly limited, the content is preferably 1 to 50 parts by weight, more preferably 1 to 40 parts by weight per 100 parts by weight of the active material.

The negative electrode is prepared, for example, by filling pores of a porous substrate with a mixture (negative electrode mixture) of an active material, a conductive material, a binder and a dispersing medium, or by injecting the mixture into the pores, and then drying. After that, rolling or pressing may be performed according to need.

The binder may be a material electrochemically inert to Li in a charge/discharge potential range of a negative electrode and having as little impact as possible to other substances. For example, styrene-butadiene rubber, polyacrylic acid, polyethylene, polyurethane, polymethyl methacrylate, polyvinylidene fluoride, polytetrafluoroethylene, carboxymethylcellulose or methylcellulose is used. Of them, styrene-butadiene rubber and polyacrylic acid capable of maintaining a firm binding state even in volume change of the negative electrode are preferred because the negative electrode of the present invention has large volume change in charging. The amount of the binder added to the negative electrode may be accordingly determined considering retention of the current collection properties of the negative electrode and improvement of battery capacity and discharge characteristics.

(5) Non-Aqueous Electrolyte Secondary Battery

The non-aqueous electrolyte secondary battery of the present invention has the above negative electrode, a positive electrode capable of reversibly absorbing and desorbing Li and a non-aqueous electrolyte.

The non-aqueous electrolyte is composed of, for example, a non-aqueous solvent and a supporting salt in the solvent.

Examples of non-aqueous solvents include cyclic carbonates such as ethylene carbonate (EC), propylene carbonate (PC), butylene carbonate (BC) and vinylene carbonate (VC); linear carbonates such as dimethyl carbonate (DMC), diethyl carbonate (DEC), ethyl methyl carbonate (EMC) and dipropyl carbonate (DPC); aliphatic carboxylic acid esters such as methyl formate, methyl acetate, methyl propionate and ethyl propionate; γ-lactones such as γ-butyrolactone; linear ethers such as 1,2-dimethoxyethane (DME), 1,2-diethoxyethane (DEE) and ethoxymethoxyethane (EME); cyclic ethers such as tetrahydrofuran and 2-methyltetrahydrofuran; and aprotic organic solvents such as dimethylsulfoxide, 1,3-dioxolane, formamide, acetamide, dimethylformamide, dioxolane, acetonitrile, propylnitrile, nitromethane, ethyl monoglyme, phosphotriester, trimethoxymethane, dioxolane derivatives, sulfolane, methyl sulfolane, 1,3-dimethyl-2-imidazolidinone, 3-methyl-2-oxazolidinone, propylene carbonate derivatives, tetrahydrofuran derivatives, ethyl ether, 1,3-propanesultone, anisole, N-methylpyrrolidone, butyl diglyme, and methyl tetraglyme. Preferably, these are used in combination of two or more.

Examples of supporting salts include LiClO₄, LiBF₄, LiPF₆, LiAlCl₄, LiSbF₆, LiSCN, LiCF₃SO₃, LiCF₃CO₂ and Li(CF₃SO₂)₂, LiAsF₆, LiB₁₀Cl₁₀, lower aliphatic carboxylic acid lithium, LiCl, LiBr, LiI, chloroborane lithium, lithium tetraphenylborate and imide. These may be used alone or in combination of two or more. Although the concentration of the supporting salt in the electrolyte is not particularly limited, the concentration is preferably 0.2 to 2.0 mol/L. The concentration is more preferably 0.5 to 1.5 mol/L.

In addition to the above electrolytes, the non-aqueous electrolyte may be gel electrolyte or solid electrolyte.

The positive electrode is not particularly limited as long as it can be used in a non-aqueous electrolyte secondary battery. The positive electrode comprises, for example, a positive electrode active material, a conductive material and a binder. The positive electrode active material is not particularly limited as long as it can be used in a non-aqueous electrolyte secondary battery. The positive electrode active material is preferably a lithium-containing transition metal compound.

Examples of lithium-containing transition metal compounds include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiCo₁₋ₓMgₓO₂, LiNi_{1-y}Co_{y}O₂ and LiNi_{1-y-z}Co_{y}Mn_{z}O₂.

In the above lithium-containing transition metal compounds, M is at least one selected from the group consisting of Na, Mg, Sc, Y, Mn, Fe, Co, Ni, Cu, Zn, Al, Cr, Pb, Sb and B. Also, x=0 to 1.2, y=0 to 0.9, z=2.0 to 2.3, and value x varies in accordance with charge/discharge of batteries.

In addition to the above materials, examples of positive electrode active materials include transition metal chalcogenide, vanadium oxide and lithium compounds thereof, niobium oxide and lithium compounds thereof, conjugated polymer and Chevrel phase compounds. These compounds may be used alone or in combination of two or more.

As a separator disposed between the positive electrode and the negative electrode, a microporous thin film having high ion permeability, a predetermined mechanical strength and electron insulation properties is used. As such a microporous thin film, for example, sheets, nonwoven fabrics and woven fabrics made of glass fiber are used. Polypropylene, polyethylene, polyphenylene sulfide, polyethylene terephthalate, polyamide and polyimide are preferred as a material of the separator since they have excellent resistance to a non-aqueous solvent and hydrophobicity. These materials may be used alone or in combination of two or more. In consideration of the production cost, inexpensive polypropylene is preferably used.

For a battery to have reflow resistance, polyethylene terephthalate, polyamide or polyimide having a heat deformation temperature of 230° C. or more, for example, is preferably used. The separator has a thickness of, for example, 10 to 300 μm. Although the void content of the separator is determined based on electron conductivity, ion permeability materials, or the like, the separator has a void content of, for example, 30 to 80%.

The negative electrode of the present invention can be applied to non-aqueous electrolyte secondary batteries of various shapes including cylindrical, flat, coin-type and square batteries. The shape of batteries is not particularly limited. The present invention can be applied to batteries of various sealing forms including batteries containing power generating elements such as electrodes and electrolyte in a metal battery can or a laminate film case. The sealing form of batteries is not particularly limited.

In the following, Examples of the present invention are described in detail, but the present invention is not limited to these Examples.

### EXAMPLE 1

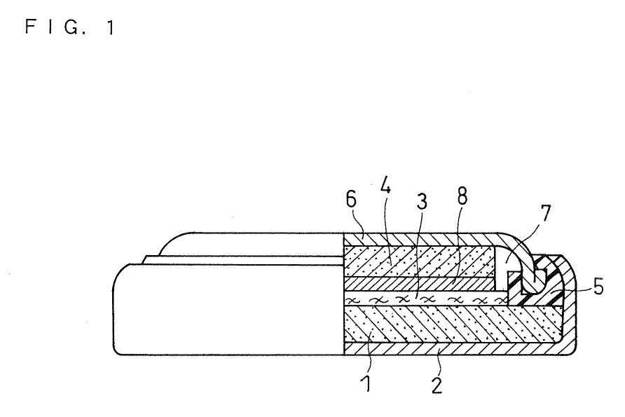

A coin type battery shown in FIG. 1, which is the non-aqueous electrolyte secondary battery of the present invention, was prepared by the following procedure. FIG. 1 is a front view of the coin type battery with a portion shown in a cross-section.

(1) Preparation of Negative Electrode Active Material

Ti powder (purity: 99.9%, particle size: 100 to 150 μm) and Si powder (purity: 99.9%, average particle size: 3 μm) were mixed so that the resulting alloy was composed of a TiSi₂ phase (B phase) and a Si phase (A phase) and the Si phase content in the alloy was 20 parts by weight per 100 parts by weight of the total of the Si phase and the TiSi₂ phase.

3.5 kg of the mixed powder prepared above was put in the container of a vibrating mill (made by CHUO KAKOHKI CO., LTD., Model FV-20). Further, stainless steel balls (diameter: 2 cm) were put in the container so that the balls account for 70% by volume of the container volume. After evacuating the container, argon gas (purity: 99.999% available from Nihonsanso Co., Ltd.) was introduced into the container so that the pressure was 1 atm. Mechanical alloying was performed for 80 hours to give Ti—Si alloy powder. At this stage, for working conditions of the mill, the vibration amplitude was 8 mm and the rotation number was 1200 rpm. The resulting Ti—Si alloy powder was classified into powder of less than 20 μm with a sieve to prepare a negative electrode active material.

The Ti—Si alloy prepared above was subjected to X-ray diffractometry using CuKα as a radiation source. The resulting X-ray diffraction pattern of the measurement showed that the alloy was low crystalline. The particle size of crystal particles (crystallites) of the alloy was calculated from the half width of the diffraction peak with the highest intensity observed in a diffraction angle 2θ range of 10 to 80° in the resulting X-ray diffraction pattern based on the Scherrer formula. As a result, the particle size of crystal particles of the alloy was found to be 10 nm. The result of the X-ray diffractometry showed that a single-element Si phase and a TiSi₂ phase were present in the alloy. As a result of calculating the weight ratio of the single-element Si phase and the TiSi₂ phase assuming that the main part of the alloy is composed of the two phases, Si:TiSi₂=20:80.

Observation of a cross section of the Ti—Si alloy by transmission electron microscopy (TEM) showed that the alloy was amorphous and a single-element Si phase composed of crystal particles having a particle size of about 10 nm and a TiSi₂ phase composed of crystal particles having a particle size of about 15 to 20 nm were present.

(2) Preparation of Porous Substrate

A porous substrate was prepared by rolling a cloth available from Mitsubishi Rayon (product name: PYROFIL) so that the cloth had a thickness of 300 μm and a porosity of 20%. The porous substrate made of the cloth had an average pore size of about 50 μm.

(3) Preparation of Conductive Material

A carbon nanotube (CNT) was prepared by the following method.

Fe fine powder having an average particle size of 10 to 500 nm was used as the catalyst in the process of preparing CNT. As the catalyst, Fe—Ni alloy, Fe—Mn alloy, Cu—Ni alloy, Co—Ni alloy, Co—Fe alloy, Co metal and MgO metal oxide, for example, may also be used in addition to Fe.

The catalyst was previously activated by heating in a mixed gas atmosphere containing He and H₂. The activated catalyst was put in a heat treating furnace and then a raw material gas (a mixed gas containing CO and H₂) was fed to the heat treating furnace, and the content was maintained at 700° C. for 1 to 10 hours. CNT was grown in the presence of a catalyst in such a manner. Although a mixed gas containing CO and H₂ was used as a raw material gas in the above, C₂H₂ or C₆H₆ may also be used instead of CO.

Since the resulting CNT contained the catalyst, the catalyst was removed from CNT by dipping in an acidic solution of nitric acid, hydrochloric acid or hydrofluoric acid. The resulting CNT had an average fiber diameter of 20 nm and an average fiber length of 20 μm.

(4) Preparation of Negative Electrode

The negative electrode active material and CNT prepared above, and polyacrylic acid (available from Wako Pure Chemical Industries, Ltd., average molecular weight: 150,000) as a binder, were mixed at a weight ratio of 90:5:5 to give a negative electrode mixture. A porous substrate was filled with the negative electrode mixture and dried at 200° C. for 12 hours. Subsequently, the substrate filled with the negative electrode mixture was rolled to give a pellet molded article having a porosity of 20%, a diameter of 4 mm and a thickness of 250 μm as a negative electrode 4.

(5) Preparation of Positive Electrode

Manganese dioxide powder (average particle size: 20 μm) and lithium hydroxide powder (average particle size: 20 μm) were mixed at a molar ratio of 2:1. The mixed powder was baked in air at 400° C. for 12 hours to give lithium manganate.

The lithium manganate powder (average particle size: 20 μm) and carbon black which is a conductive material and polytetrafluoroethylene which is a binder were mixed at a weight ratio of 88:6:6 to give a positive electrode mixture. The binder was used in the form of an aqueous dispersion. The positive electrode mixture was formed into pellet having a diameter of 4 mm and a thickness of 1.0 mm. Subsequently, the pellet was dried at 250° C. for 12 hours to prepare a positive electrode 1.

(6) Preparation of Coin Type Battery

A battery case was fabricated from a stainless steel positive electrode can 2 which also serves as a positive electrode terminal and a stainless steel negative electrode can 6 which also serves as a negative electrode terminal. When fabricating the battery case, a positive electrode 1, a separator 3 (thickness: 200 am) made of polyethylene nonwoven fabric, a negative electrode 4 and metal lithium 8 (thickness: 200 μm) were put inside. At this stage, the separator 3 was disposed between the positive electrode 1 and the negative electrode 4, the lithium plate 8 was disposed between the negative electrode 4 and the separator 3. In other words, the positive electrode 1, the separator 3, the lithium plate 8 and the negative electrode 4 were disposed on the positive electrode can 2 in that order so that the positive electrode 1 came in contact with the positive electrode can 2 and the negative electrode 4 came in contact with the negative electrode can 6. An electrolyte was injected into a space 7 inside the battery case so that the positive electrode 1, the negative electrode 4 and the separator 3 were impregnated with the electrolyte. 1 mol/L LiN(CF₃SO₂)₂ dissolved in a mixed solvent of PC, EC and DME (volume ratio: PC:EC:DME=1:1:1) was used as the electrolyte. To insulate the positive electrode can 2 and the negative electrode can 6, a polypropylene gasket 5 was disposed between the positive electrode can 2 and the negative electrode can 6. Pitch was applied to the surface of the positive electrode can 2 and the surface of the negative electrode can 6 which came in contact with the gasket 5. A coin type battery having an outer diameter of 6.8 mm and a thickness of 2.1 mm was thus prepared.

### EXAMPLE 2

A porous substrate was prepared by rolling a felt available from Kureha Corporation (product name: KURECA felt) so that the felt had a thickness of 300 μm and a porosity of 20%. The porous substrate made of the felt had an average pore size of about 50 μm. A battery was prepared in the same manner as in Example 1 using the porous substrate.

### EXAMPLE 3

A porous substrate was prepared by rolling a paper available from TORAY INDUSTRIES, INC (product name: Carbon Paper) so that the paper had a thickness of 300 μm and a porosity of 20%. The porous substrate made of the paper had an average pore size of about 50 μm. A battery was prepared in the same manner as in Example 1 using the porous substrate.

### EXAMPLES 4 TO 6

Ti powder (purity: 99.9%, particle size: 100 to 150 μm) and Sn powder (purity 99.9%, average particle size: 3 nm) were mixed so that the composition of the resulting alloy was Ti₆Sn₅. Mechanical alloying was performed in the same manner as in the case of TiSi₂ except for the above to give Ti₆Sn₅ powder. The alloy composition and crystallinity were observed in the same manner as described above. As a result, the alloy was found to be composed of a Ti₆Sn₅ phase and amorphous. Batteries were prepared in the same manner as in Examples 1 to 3 using the Ti₆Sn₅ powder prepared above as a negative electrode active material.

### EXAMPLES 7 TO 9

SiO (available from SUMITOMO TITANIUM CORPORATION) was pulverized and the resulting powder was classified into powder of less than 20 μm with a sieve to prepare a negative electrode active material. The crystallinity of the negative electrode active material is observed in the same manner as described above. As a result, the negative electrode active material was found to be amorphous or low crystalline. Batteries were prepared in the same manner as in Examples 1 to 3 using the negative electrode active material.

### EXAMPLES 10 TO 12

SnO (available from KOJUNDO CHEMICAL LABORATORY CO., LTD.) was pulverized and the resulting powder was classified into powder of less than 20 μm with a sieve to prepare a negative electrode active material. The crystallinity of the negative electrode active material is observed in the same manner as described above. As a result, the negative electrode active material was found to be amorphous or low crystalline. Batteries were prepared in the same manner as in Examples 1 to 3 using the negative electrode active material.

### COMPARATIVE EXAMPLE 1

A negative electrode was prepared using a negative electrode mixture alone without using a porous substrate. Specifically, after molding the same negative electrode mixture as that in Example 1 into pellet of a diameter of 4 mm and a thickness of 1.0 mm, the pellet was dried at 250° C. for 12 hours to give a negative electrode composed of a negative electrode mixture layer. A battery was prepared in the same manner as in Example 1 using the negative electrode.

### COMPARATIVE EXAMPLES 2 TO 4

A negative electrode was prepared in the same manner as in Example 1 except that CNT was not added to the negative electrode mixture. A battery was prepared in the same manner as in Example 1 using the negative electrode.

[Evaluation of Batteries]

A charge/discharge cycle test was performed for the batteries of Examples 1 to 12 and Comparative Examples 1 to 4 in a constant temperature bath set at 20° C. Each battery was charged and discharged with a constant current of 2 CA (1 C representing current at 1 hour rate). Charge/discharge was repeated for 200 cycles in a battery voltage range of 2.0 V to 3.3 V.

At this stage, the discharge capacity at the second cycle was determined to be the initial discharge capacity. Also, the ratio of the discharge capacity at the 200th cycle to the discharge capacity at the second cycle was determined in percentage (%) and defined as the capacity maintenance rate. The closer the capacity maintenance rate to 100(%), the better the charge/discharge cycle performance.

TABLE 1

| | | | | Battery | |
|---|---|---|---|---|---|
| | Negative electrode | | | characteristics | |
| | Negative | | | Initial | |
| | electrode | | | discharge | Capacity |
| | active | | Conductive | capacity | maintenance |
| | material | Substrate | material | (mAh) | rate (%) |
| Example 1 | Ti—Si | Cloth | CNT | 6 | 95 |
| Example 2 | Ti—Si | Felt | CNT | 5.9 | 90 |
| Example 3 | Ti—Si | Paper | CNT | 5.9 | 90 |
| Example 4 | Ti₆Sn₅ | Cloth | CNT | 6 | 95 |
| Example 5 | Ti₆Sn₅ | Felt | CNT | 5.9 | 90 |
| Example 6 | Ti₆Sn₅ | Paper | CNT | 5.9 | 90 |
| Example 7 | SiO | Cloth | CNT | 6 | 95 |
| Example 8 | SiO | Felt | CNT | 5.9 | 90 |
| Example 9 | SiO | Paper | CNT | 5.9 | 90 |
| Example 10 | SnO | Cloth | CNT | 6 | 95 |
| Example 11 | SnO | Felt | CNT | 5.9 | 90 |
| Example 12 | SnO | Paper | CNT | 5.9 | 90 |
| Comparative | Ti—Si | None | CNT | 5.9 | 70 |
| Example 1 | | | | | |
| Comparative | Ti—Si | Cloth | None | 6 | 75 |
| Example 2 | | | | | |
| Comparative | Ti—Si | Felt | None | 5.9 | 70 |
| Example 3 | | | | | |
| Comparative | Ti—Si | Paper | None | 5.9 | 70 |
| Example 4 | | | | | |

The batteries of Examples 1 to 12 had higher capacity maintenance rate than those in Comparative Examples 1 to 4.

This seems to be because use of the porous substrate suppressed cracks of the active material or falling off of the active material in the negative electrode even in the case of large volume change of active material particles in charge/discharge and the form of the negative electrode was maintained. The above also seems to be because a good current collection network of active material particles was maintained by using a fibrous conductive material having a fiber diameter smaller than the pore size of the porous substrate.

### EXAMPLES 13 TO 20 AND COMPARATIVE EXAMPLES 5 TO 7

Batteries were prepared in the same manner as in Example 1 using porous substrates shown in Table 2.

Product name Celmet available from Sumitomo Electric Industries, Ltd. was used as a Ni foamed body. Other foamed bodies were prepared by applying a slurry containing metal powder (average particle size: 1 μm or less) to a foamed urethane resin and heat treating at 500° C.

Sintered bodies were prepared by molding metal powder (average particle size: 1 μm or less), forming a porous material, and then heat treating. Powder of nickel, copper, titanium or stainless steel was used as metal powder.

The batteries were evaluated in the same manner as described above. The evaluation results are shown in Table 2.

TABLE 2

| | | | Battery characteristics | |
|---|---|---|---|---|
| | | | Initial | |
| | Negative electrode | | discharge | Capacity |
| | | Conductive | capacity | maintenance |
| | Substrate | material | (mAh) | rate (%) |
| Example 13 | Ni foamed | CNT | 6 | 90 |
| | body | | | |
| Example 14 | Cu foamed | CNT | 5.9 | 85 |
| | body | | | |
| Example 15 | Ti foamed | CNT | 6 | 85 |
| | body | | | |
| Example 16 | SUS foamed | CNT | 5.9 | 90 |
| | body | | | |
| Example 17 | Ni sintered | CNT | 6 | 90 |
| | body | | | |
| Example 18 | Cu sintered | CNT | 5.9 | 85 |
| | body | | | |
| Example 19 | Ti sintered | CNT | 6 | 85 |
| | body | | | |
| Example 20 | SUS sintered | CNT | 5.9 | 90 |
| | body | | | |
| Comparative | None | CNT | 5.9 | 70 |
| Example 5 | | | | |
| Comparative | Ni foamed | None | 6 | 75 |
| Example 6 | body | | | |
| Comparative | Ni sintered | None | 5.9 | 70 |
| Example 7 | body | | | |

The batteries of Examples 13 to 20 have a higher capacity maintenance rate than those in Comparative Examples 5 to 7. Substrates are not limited to foamed bodies or sintered bodies, and the same advantage as described above can be achieved as long as the conductive substrate has pores.

### EXAMPLE 21

Batteries 1 to 4 were prepared in the same manner as in Example 1 using various conductive materials shown in Table 3.

As a particulate conductive material, commercially available acetylene black (AB) (average primary particle size: 20 nm) or ketjen black (KB) (average primary particle size: 20 nm) was used.

As a fibrous conductive material, carbon nanotube (CNT) or carbon nanofiber (CNF) was used. The same CNT as that in Example 1 was used as the CNT. CNF was prepared in the same manner for preparing CNT as in Example 1 except that the heat treatment temperature was 1000° C. CNT had an average fiber diameter of 20 nm and an average fiber length of 20 μm. CNF had an average fiber diameter of 20 nm and an average fiber length of 20 μm.

The batteries were evaluated in the same manner as described above. The evaluation results are shown in Table 3.

TABLE 3

Battery characteristics

| | Conductive | Initial | Capacity |
|---|---|---|---|
| Battery | material of | discharge | maintenance |
| No. | negative electrode | capacity (mAh) | rate (%) |
| 1 | AB | 6 | 85 |
| 2 | KB | 5.9 | 85 |
| 3 | CNT | 6 | 95 |
| 4 | CNF | 5.9 | 95 |

The batteries 1 to 4 had high capacity maintenance rate. The same advantage as described above can also be achieved even when using the cloth or felt in Example 2 or 3 as the substrate.

### EXAMPLE 22

Batteries 5 to 12 were prepared in the same manner as in Example 1 using various conductive materials shown in Table 4. Particulate metal or fibrous metal was used as the conductive materials. The particulate metal had an average particle size of 50 nm. The fibrous metal had an average fiber diameter of 20 nm and an average fiber length of 20 μm. Nickel, copper, titanium or stainless steel was used as the metal. The batteries were evaluated in the same manner as described above. The evaluation results are shown in Table 4.

TABLE 4

| | | | Battery characteristics | |
|---|---|---|---|---|
| | Conductive material of | | Initial | Capacity |
| Battery | negative electrode | | discharge | maintenance |
| No. | Type | Form | capacity (mAh) | rate (%) |
| 5 | Ni | Particulate | 5.8 | 80 |
| 6 | Ni | Fibrous | 5.9 | 85 |
| 7 | Ti | Particulate | 5.8 | 80 |
| 8 | Ti | Fibrous | 5.8 | 85 |
| 9 | Cu | Particulate | 5.8 | 80 |
| 10 | Cu | Fibrous | 5.8 | 85 |
| 11 | SUS | Particulate | 5.8 | 80 |
| 12 | SUS | Fibrous | 5.8 | 85 |

The batteries 5 to 12 had high capacity maintenance rate. The same advantage as described above can also be achieved even when using the cloth or felt in Example 2 or 3 as the substrate.

### EXAMPLE 23

As shown in Table 5, batteries 13 to 26 were prepared in the same manner as in Example 1 except that paper having a different average pore size was used as the porous substrate and particulate carbon having a different average particle size was used as the conductive material. The average pore size of the porous substrate was controlled by changing the content of carbon material in the raw materials when preparing the paper. The batteries were evaluated in the same manner as described above. The evaluation results are shown in Table 5.

TABLE 5

| | | Average | Battery characteristics | |
|---|---|---|---|---|
| | | particle | Initial | |
| | Average pore | size (nm) of | discharge | Capacity |
| Battery | size (μm) of | conductive | capacity | maintenance |
| No. | substrate | material | (mAh) | rate (%) |
| 13 | 0.5 | 20 | 5.8 | 60 |
| 14 | 1 | 20 | 5.9 | 85 |
| 15 | 5 | 20 | 5.8 | 80 |
| 16 | 20 | 20 | 5.8 | 85 |
| 17 | 50 | 20 | 5.8 | 80 |
| 18 | 100 | 20 | 5.8 | 85 |
| 19 | 150 | 20 | 5.8 | 60 |
| 20 | 20 | 1 | 5.8 | 60 |
| 21 | 20 | 5 | 5.9 | 85 |
| 22 | 20 | 10 | 5.8 | 80 |
| 23 | 20 | 20 | 5.8 | 85 |
| 24 | 20 | 50 | 5.8 | 80 |
| 25 | 20 | 100 | 5.8 | 85 |
| 26 | 20 | 150 | 5.8 | 60 |

The batteries 14 to 18 in which the porous substrate has an average pore size of 1 to 100 μm had higher capacity maintenance rate. The batteries 21 to 25 in which the conductive material has an average particle size of 5 to 100 nm had higher capacity maintenance rate. The same advantage as described above can also be achieved even when using the cloth or felt in Example 2 or 3 as the substrate.

### EXAMPLE 24

As shown in Table 6, batteries 27 to 40 were prepared in the same manner as in Example 1 except that the average fiber diameter and the average fiber length of the fibrous conductive material (CNT) were changed. The average fiber diameter and the average fiber length of the CNT were controlled by changing the heat treatment temperature and time, and the average particle size of the catalyst powder when preparing the CNT. The batteries were evaluated in the same manner as described above. The evaluation results are shown in Table 6.

TABLE 6

| | Average fiber | Average fiber | |
|---|---|---|---|
| | diameter (nm) of | length (μm) of | Capacity |
| Battery | conductive | conductive | maintenance |
| No. | material | material | rate (%) |
| 27 | 20 | 0.01 | 60 |
| 28 | 20 | 0.05 | 85 |
| 29 | 20 | 0.5 | 80 |
| 30 | 20 | 2 | 85 |
| 31 | 20 | 20 | 80 |
| 32 | 20 | 50 | 85 |
| 33 | 20 | 70 | 60 |
| 34 | 1 | 20 | 60 |
| 35 | 5 | 20 | 85 |
| 36 | 10 | 20 | 80 |
| 37 | 20 | 20 | 85 |
| 38 | 30 | 20 | 80 |
| 39 | 50 | 20 | 85 |
| 40 | 70 | 20 | 60 |

The batteries 28 to 32 and 35 to 39 in which the CNT has an average fiber diameter of 5 to 50 nm and an average fiber length of 0.05 to 50 μm had higher capacity maintenance rate. The same advantage as described above can also be achieved even when using the cloth or felt in Example 2 or 3 as the substrate. The same advantage as described above can also be achieved when the porous substrate has an average pore size of 1 to 100 μm.

### EXAMPLE 25

As shown in Table 7, batteries 41 to 47 were prepared in the same manner as in Example 1 except that the porosity of the negative electrode was changed. The porosity of the negative electrode was controlled by changing the force applied in rolling at the time of molding. The batteries were evaluated in the same manner as described above. The evaluation results are shown in Table 7.

TABLE 7

| Battery | Porosity (%) of negative | Capacity maintenance |
|---|---|---|
| No. | electrode | rate (%) |
| 41 | 2 | 60 |
| 42 | 5 | 90 |
| 43 | 10 | 90 |
| 44 | 20 | 95 |
| 45 | 30 | 95 |
| 46 | 50 | 90 |
| 47 | 70 | 60 |

The batteries 42 to 46 in which the porosity is 5 to 50% had higher capacity maintenance rate. The same advantage as described above can also be achieved even when using the cloth or felt in Example 2 or 3 as the substrate.

The non-aqueous electrolyte secondary battery of the present invention has high capacity and excellent cycle properties and is preferably used as a main power supply for various electronic devices such as mobile phones and digital cameras or a backup power supply.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a non-aqueous electrolyte secondary battery comprising a conductive porous substrate, and a conductive material and an active material filled in pores of said porous substrate,
wherein said active material comprises at least one of a metal element and a semi-metal element capable of reversibly absorbing and desorbing lithium.

2. The negative electrode for a non-aqueous electrolyte secondary battery in accordance with claim 1, wherein said porous substrate comprises at least one selected from the group consisting of nickel, copper, titanium, stainless steel and carbon.

3. The negative electrode for a non-aqueous electrolyte secondary battery in accordance with claim 1, wherein said conductive material comprises at least one selected from the group consisting of nickel, copper, titanium, stainless steel and carbon.

4. The negative electrode for a non-aqueous electrolyte secondary battery in accordance with claim 2, wherein said conductive material is at least particulate or fibrous.

5. The negative electrode for a non-aqueous electrolyte secondary battery in accordance with claim 4, wherein said porous substrate has an average pore size of 1 to 100 μm and said conductive material comprises particles having an average particle size of 5 to 100 nm.

6. The negative electrode for a non-aqueous electrolyte secondary battery in accordance with claim 4, wherein said porous substrate has an average pore size of 1 to 100 μm and said conductive material comprises fibers having an average fiber diameter of 5 to 50 nm and an average fiber length of 0.05 to 50 μm.

7. The negative electrode for a non-aqueous electrolyte secondary battery in accordance with claim 1, wherein said porous substrate is in the form of a foamed body or a sintered body comprising at least one selected from the group consisting of nickel, copper, titanium and stainless steel.

8. The negative electrode for a non-aqueous electrolyte secondary battery in accordance with claim 1, wherein said porous substrate is in the form of at least one selected from the group consisting of cloth, felt and paper which comprises carbon.

9. The negative electrode for a non-aqueous electrolyte secondary battery in accordance with claim 4, wherein said conductive material is at least one of carbon nanotube and carbon nanofiber.

10. The negative electrode for a non-aqueous electrolyte secondary battery in accordance with claim 1, wherein said active material comprises at least one of Si and Sn.

11. The negative electrode for a non-aqueous electrolyte secondary battery in accordance with claim 1, wherein said active material is an alloy comprising a first phase containing Si as a main component and a second phase containing Si and at least one selected from Ti, Zr, Ni and Cu, and wherein at least one of said first phase and said second phase is in at least one of amorphous and low crystalline states.

12. The negative electrode for a non-aqueous electrolyte secondary battery in accordance with claim 1, wherein said active material is at least one of SiOₓ where 0.1≦x≦2.0 and SnO_{y} where 0.1≦y≦2.0.

13. The negative electrode for a non-aqueous electrolyte secondary battery in accordance with claim 1, wherein said negative electrode has a porosity of 5 to 50%.

14. A non-aqueous electrolyte secondary battery comprising the negative electrode in accordance with claim 1, a positive electrode, and an electrolyte.
